(19) United States
(12) Patent Application Publication
(10) Pub. No.: US 2007/0003858 A1
(43) Pub. Date: Jan. 4, 2007

(54) Toner, toner producing method, and image forming method

(76) Inventors: Yoshiaki Akazawa, Nara (JP); Rika Hayashi, Nara (JP)

Correspondence Address: NIXON & VANDERHYE, PC, 901 NORTH GLEBE ROAD, 11TH FLOOR, ARLINGTON, VA, 22203, US

(21) Appl. No.: 10/556,534

(22) PCT Filed: May 20, 2004
(86) PCT No.: PCT/JP04/06842

§ 371 Date: Nov. 14, 2005

(30) Foreign Application Priority Data
May 21, 2003 (JP) 2003-143348

(51) Int. Cl. G03G 9/08

(52) U.S. Cl. 430/124; 430/108.1; 430/137.18

(57) ABSTRACT

A toner is provided for forming an image on a sheet of ordinary paper using a small amount of toner which is favorable in the density, less in the difference in reflection between toner layers thereof in each color. Even when the toner is small in the consumption, its image can be high in the density and uniform in the color reproduction. The toner contains a binding resin and a coloring pigment, the coloring pigment ranging from 5 percent to 20 percent by weight, wherein the average volumetric particle diameter D is 3 to 9 μm. The calculated average surface roughness Rs of a solid image developed and fixed at 0.2 to 0.5 mg/cm² of the adhered amount M on a transfer medium of which the calculated average surface roughness Rp is 5 to 7 μm, satisfies an relational expression Rs/Rp≦0.6×D/(10 M/ρ), where ρ is the true specific gravity of the toner in g/cm³.

This application is the national phase under 35 U.S.C. § 371 of PCT International Application No. PCT/JP2004/006842 which has an International filing data of May 20, 2004, which designated the United States of America.

### TECHNICAL FIELD

The present invention relates to an image forming method of converting from an electric or magnetic latent image of the original to a visual image with the use of toner powder and transferring the toner image onto a printing medium (e.g., a sheet of paper) before heating up for fixing in an image forming apparatus such as an electronic photographic type copier or printer. It also relates to a toner for use in the image forming method which is arranged for development of electronic photograph through a one-component or two-component development technique and to a method of producing the toner.

### BACKGROUND ART

In the electronic photography industry, a variety of attempts have been made for having its relevant machines, including copiers and printers, decreased in the size, increased in the operating speed, and improved in the quality of images. Attempts for decreasing the size are particularly concerned in each step such as the developing system and the fixing system of the electronic photography process application. In the field of the developer, since its feeding section such as a toner hopper has to be minimized in the overall size and increased in the operating life, the toner for producing a more number of copies or prints with a small of its consumption is also a target.

For improving the image quality, there are known some preferable techniques such as generating high quality images at improved clarity through controlling the granular degree (the size) of toner particles of a developer, the electrical properties of a toner or the like, generating high quality images at improved density through modifying the color characteristics of a toner, including the color development, the transparency, and the opacity, and increasing the concentration of a coloring agent in a toner respectively. Also the planar or offset printing technology employs a printing liquid (ink) which is deposited less in the thickness on a recording medium than the toner of the electronic photography technology, thus producing uniform quality images at higher density.

### DISCLOSURE OF THE INVENTION

In the electronic photography technology, its full color images at different color grades are printed through depositing and fixing a combination of three color processing toners, yellow, magenta, and cyan, and one black toner. The toners (printing materials) on a printing medium are varied in the thickness depending the color. More specifically, as the toners are also varied in the reflection of light, their images may significantly be discriminated from those of the planar printing technology. It is hence necessary for producing uniform, explicit, high quality images in the electronic photography technology to modify the thickness of images to a small while not declining the density grade.

It is however essential for producing high quality images from a smaller amount of the toner than that of the prior art to eliminate undulations but provide smoothness and uniformity at the surface of the images. Particularly, when undulations at their surface are caused by entanglement of the fibers of printing paper as the printing medium such as ordinary paper for PPC (plain paper copy) sheets, the images have to be printed with careful adjustment depending on the state of the undulations.

Disclosed in Japanese Patent Application Laid-open No. 2001-142329 is a full color toner fixing method where the roughness Rz at the surface of an image to be fixed in a belt fixing system is controlled to smaller than 8 μm while the difference between the roughness Rz and the maximum height Rmax at the peak of undulations at the surface of the fixed image remains not higher than 10 μm. However, the disclosure teaches that the amount of a toner for the image is not smaller than 0.9 mg/cm². This can easily be anticipated from a common fixing manner when the toner has completely been fused. It fails to describe an arrangement for producing a solid image (a flat image) of a desired quality from a small amount of the toner.

The present invention has been developed in view of the foregoing aspects and its object is to provide a toner, a toner producing method, and an image forming method with the toner, where an image is formed on a sheet of ordinary paper with the use of a small amount of the toner. The formed image is favorable in the density, less in the difference in reflection between toner layers thereof in each color. Even when the toner is small in the consumption, the image can be high in the density and uniform in the color reproduction.

The transfer medium used in the method according to the present invention is so-called ordinary paper for the electronic photography printing technology, of which the calculated average surface roughness may range from 5 μm to 7 μm. When its calculated average surface roughness is greater than 7 μm, the transfer medium will fail to have an image, which is uniform in the toner layers, permitting only a poor level of the image quality. Also, for producing a toner image of higher quality, the transfer medium used in the method according to the present invention may be selected from the particular kind of paper such as resin coated paper of which the calculated average surface roughness is not greater than 5 μm or art paper. The present invention, however, is directed towards formation of an explict image with the use of a small amount of the toner on a sheet of ordinary printing paper.

The toner according to the present invention is provided containing a binding resin and a coloring pigment where the coloring pigment ranges from 5 percent by weight to 20 percent by weight and the average volumetric particle diameter D is 3 to 9 μm. In particular, the toner is characterized in that the calculated average surface roughness Rs of a solid image developed and fixed at 0.2 to 0.5 mg/cm² of the adhered amount M on a transfer medium of which the calculated average surface roughness Rp is 5 to 7 μm satisfies a relational expression Rs/Rp≦0.6×D/(10 M/ρ) where ρ is the true specific gravity of the toner in g/cm³.

Using the toner, a toner image (a solid image) is developed and fixed on the transfer medium, of which the surface roughness can be controlled to a desired range in relation to the surface roughness of the transfer medium before the development of the image. Also, as the pigment in the toner is favorably modified in the concentration for determining a desired fusing characteristic, a toner image at high density and quality can be developed from a small amount of the toner.

More specifically for developing a toner image at desired density from a small amount of the toner, the toner comprising at least a binding resin and a coloring pigment, the coloring pigment ranging from 5 percent by weight to 20 percent by weight and the average volumetric particle diameter D being 3 to 9 μm is arranged in which the ratio, Rs/Rp, of the calculated average surface roughness Rs of a solid image in each color developed and fixed on the transfer medium to the calculated average surface roughness Rp of the transfer medium (Rp being 5 to 7 μm) is not greater than 0.6 times the value determined by D/(10 M/ρ) where D is the volumetric average particle diameter of the toner, M is the amount per unit area of the toner, and ρ is the true specific gravity expressed in g/cm³.

If the ratio of its calculated average surface roughness to the calculated average surface roughness of the transfer medium is greater than 0.6 times the value determined by D/(10 M/ρ), the toner image will be declined in the surface smoothness while simultaneously encouraging the effect of undulations on the transfer medium. As a result, the formed image will have a poor density and fail to produce a desired level of glossiness.

According to the present invention, an image can be formed from as a small amount of the toner as 0.2 to 0.5 mg/cm², thus satisfying a variety of requirements including the downsizing of an advanced electronic photography apparatus, the improvement in the image quality, and the lower volume and long life of a developer feeding section. When the toner is smaller than 0.2 mg/cm² in the consumption, its developed image on a sheet of ordinary paper of which the calculate average surface roughness is 5 to 7 μm will fail to cover the imaging area of the paper and thus be declined in the quality. Also, when the toner is greater than 0.5 mg/cm² in the consumption, its developed image in each color will stay fine in the color development but not in a mixture of the primary colors. When the image is formed in a full-color or a secondary color such as green or blue, two or more of the color toners are deposited in layers for development of the desired full-color color. As its thickness is varied depending on the layers of the color, the formed image in the full color will hardly be uniform in the glossiness.

It is preferable for forming the image in a desired color from a small amount of toner, according to the present invention, that the concentration of the pigment as a coloring agent in the toner ranges from 5 percent by weight to 20 percent by weight. If the concentration of the pigment in the toner is lower than 5 percent by weight, the toner image deposited in layers on the transfer medium will remain low in the spectral reflectivity and thus in the optical density. Also, if the concentration of the pigment exceeds 20 percent by weight, the fusible resin component in the toner will be shortened thus lowering the fixing strength. As a result, the formed image will hardly be maintained in the quality and its clearness will be declined thus lowering the secondary color repeatability.

More specifically, it is desirable to increase the thickness of the formed image, that is, the amount of pigment in the toner when the image is developed from a small amount of toner. When the toner is consumed 0.5 mg/cm² for forming an image, the concentration of the pigment in the toner is preferably 5 to 10 percent by weight. When 0.3 mg/cm², preferably 7 to 15 percent by weight. When 0.2 mg/cm², preferably 10 to 20 percent by weight.

The toner according to the present invention may further contain 3 to 10 percent by weight of a mold lubricant.

The addition of 3 to 10 percent by weight of the mold lubricant, such as wax, eliminates the application of oil to a fixing member for fixing the toner image to the transfer medium. If the mold lubricant is lower than 3 percent by weight, the toner will be declined in the peelability from the fixing member thus producing the effect of so-called offset. When the mold lubricant exceeds 10 percent by weight, the storage stability will be declined and not practical.

The toner according to the present invention may be modified in which the ½ flow softening point temperature at which ½ the material is softened and flows ranges from 95° C. to 130° C.

It is preferable that the ½ flow softening point temperature Tm of the toner according to the present invention ranges from 95° C. to 130° C. If the temperature Tm is lower than 95° C., the storage stability will be declined. As a result, the toner may unwillingly be fused to a charging member by the effect of an external stress in the developing unit. When the temperature Tm exceeds 130° C., the fusing property will be declined thus lowering the fixing strength. Also, the color development will be declined among other drawbacks.

The toner producing method according to the present invention is characterized by, after fusing, kneading, and dispersing a mixture of materials by the fusing and kneading action of a kneader, subjecting the mixture to a crushing process to produce the toner, wherein the kneader has a first kneading roll, which has grooves for conveying the mixture and a heating region for heating the mixture, and a second kneading roll, which has a grooves for conveying the mixture and cooling region for cooling the mixture, arranged in parallel to and spaced by a gap from each other, so that the mixture is loaded with a shearing force by the first and second kneading rolls rotating in opposite directions when passing through the gap.

The toner producing method according to the present invention may employ any of known methods including a crushing method of, after mixing raw materials, dispersing a mixture through fusing and kneading and then crushing the mixture, a suspending method, an emulsifying method, and an intra-liquid drying method where a mixture is converted into particles in a water solution or a solvent. Particularly, the crushing method is preferable because it is conducted by an open roll type kneading machine where the mixture can be loaded with a high shearing force at a low temperature during the fusing and kneading action. As a result, even when its content of a pigment or wax is high, the mixture can be dispersed to a favorable extent.

The image forming method according to the present invention is characterized by developing and visualizing an electric or magnetic latent image with the use of a toner in an electronic photography technique and transferring its toner image onto a transfer medium before being heated for fixture, wherein the development is carried out using the toner described above.

The image forming method according to the present invention is to develop and visualize an electric or magnetic latent image with the use of the toner according to the invention, and transfer its toner image onto a transfer medium before being heated for fixture.

The toner according to the present invention is capable of forming an image on a sheet of ordinary paper from its small amount. The formed image is favorable in the density, less in the difference in reflection between toner layers thereof in each color. Even when the toner is small in the consumption, its image can be high in the density and uniform in the color reproduction.

The toner producing method according to the present invention allows an image to be formed on a sheet of ordinary paper with the use of a small amount of the toner. The formed image is favorable in the density, less in the difference in reflection between toner layers thereof in each color. Even when the toner is small in the consumption, its image can be high in the density and uniform in the color reproduction.

Similarly, the image forming method according to the present invention allows an image to be formed on a sheet of ordinary paper with the use of a small amount of the toner. The formed image is favorable in the density, less in the difference in reflection between toner layers thereof in each color. Even when the toner is small in the consumption, its image can be high in the density and uniform in the color reproduction.

### BRIEF DESCRIPTION OF THE DRAWINGS

FIG. 1 is a flowchart showing the toner producing method as one embodiment according to the present invention;

FIG. 2 is a schematic view of a kneading and dispersing apparatus used in the embodiment of the toner producing method of the present invention;

FIG. 3 is a table of measurements showing examples of the toner according to the present invention;

FIG. 4 is a table of measurements showing embodiments of comparison with the toner according to the present invention;

FIG. 5 is a table of measurements showing embodiments of the toner according to the present invention and examples of its comparison;

FIG. 6 is a table of measurements showing embodiments of the toner according to the present invention and examples of its comparison; and

FIG. 7 is a schematic cross sectional view showing the cross section of an image forming apparatus used preferably in the image forming method according to the present invention.

### BEST MODES FOR IMPLEMENTING THE INVENTION

Some embodiments of the present invention will be described referring to the relevant drawings.

### Embodiment 1

A toner according to the present invention is prepared containing a binding resin and a coloring pigment, and if desired, an antistatic agent and a wax material.

The binding resin in the toner according to the present invention may be selected from a variety of known materials including applicable resins. Examples of the tacking resin are styrene resin such as polystyrene or styrene-acrylic ester copolymer, vinyl chloride resin, phenol resin, epoxy resin, polyester resin, polyurethane resin, and poly vinyl butyral resin. The tacking resin may be made from any of those resins or their combination of two or more. The resin may be finely dispersed with a crystalline wax or incompatible material during the synthesizing stage. It is preferable to add with polyester resin or polyether-polyol as the main component which is higher in the thermal property such as resin elasticity.

The coloring pigment according to the present invention may be selected as a yellow pigment from a disazo pigment at C.I. pigment yellow 17, a monoazo pigment at C.I. pigment yellow 74 or 97, a condensation azo pigment at C.I. pigment yellow 93 or 128, and a benzimidazolone pigment at C.I. pigment yellow 180 or 194. The coloring pigment may be selected as a magenta pigment from a quinacridone red pigment at C.I. pigment red 122 or 202, a lake azo pigment at C.I. pigment red 57, a perylene pigment at C.I. pigment red 149, 190, or 224, and naphthol-benzimidazolone pigment at C.I. pigment red 184 or 185. The coloring pigment may be selected as a cyan pigment from phthalocyanine pigments at C.I. pigment blue 15:3 and C.I. pigment blue 15:4. The coloring agent may be selected as a black toner from known carbon black materials.

The toner according to the present invention may also contain any additive agent in addition to the binding resin and the coloring agent, such as an antistatic agent and a wax material. The antistatic agent may preferably be a colorless metallic salt antistatic agent such as, namely class 4 ammonium salt for positive electricity or alkyl salicylic acid for negative electricity. The wax material may be selected from a synthetic wax such as poly ethylene or poly propylene, a natural wax such as carnauba wax or rice wax, a silicone material, a higher fatty acid, a poly olefin, and a monomeric polymer. The wax is made of any of those materials or their combination of two or more.

The toner producing method according to the present invention includes a step of, after preparing a combination of the binding resin and the coloring agent or a master batch composition produced by dispersing the coloring agent into the binding resin in advance mixed with desired additives including the antistatic agent, the wax, and a dispersant with the use of a dry mixer, fusing and kneading the mixture for uniform dispersion, crushing, and classifying.

The mixer may be selected from a Henschel mixer (Mitsui Mines), a Super Henschel mixer (Kawada), a Mechano mill of Henschel type (Okada Machinery), an Angstrom mill (Hosokawa Micron), a Hydridisation system (Nara Machinery), and a Cosmo System (Kawasaki Heavy Industries).

The kneader may be selected from a one-axis or two-axes extruder, e.g., TEM-100B (Toshiba Machinery) or PCM-65/87 (Ikegai) and an open roll kneader, e.g., Kneadex (Mitsui Mines). The process of fusing and kneading may preferably be conducted with an open roll type kneader which can knead the mixture at low temperature and high sharing rate for dispersing the additives at high efficiency while holding the viscosity at not a too low degree during the fusing action.

The crushing of the toner particles may be conducted with a impact-type pneumatic crushing machine using a jet of air or a mechanical crushing machine for modifying the toner particles to a desired degree of granule (the size of particles) through classification by wind or the like. The toner according to the present invention may be modified by polymerization, e.g., suspension method, emulsion aggregation method, or liquid-phase drying method, for generating particles in a solution or solvent.

The toner particles generated by the foregoing manner range from 3 μm to 9 μm in the volumetric average particle diameter. Their distribution may preferably have a sharp profile. The size of the particles determined by any known crushing technique may be utilized. More specifically, the particles are controlled to not higher than 20 pop % at the volumetric average particle diameter of D50×0.5 or smaller and not higher than 2 vol % at D50×2.

The toner particles may also be subjected to external addition with a fluidizer, a static modifier, a surface resistance adjuster, or any desired agent. For the purpose, numerous fine inorganic particles may be used including silica powder, titanium oxide powder, and alumina powder. The fine inorganic particles may also be added with any desired processing agent, such as silicone varnish, modified silicone varnish, silicone oil, modified silicone oil, silane coupling agent, silane coupling agent with functional groups, or organic silicon compound, for providing a hydrophobic nature and determining a controlled level of static electricity. The processing agent may be a combination of two or more materials. Moreover, other materials may be added as lubricants, which include Teflon (a tradename), zinc stearate, polyvinylidene fluoride, and silicone oil particles (containing substantially 40% of silica). A small amount of development improver may be added in the form of white fine particles of which the polarity is opposite to that of the toner particles.

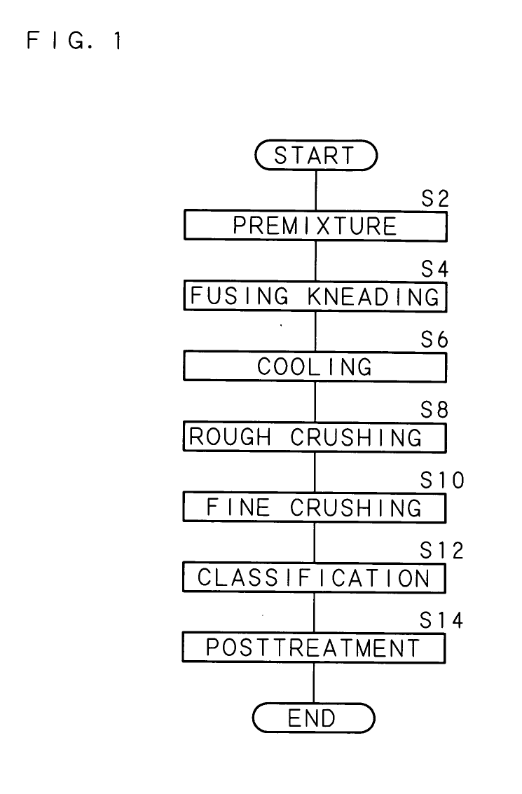

The toner producing method according to the present invention will now be explained in more detail referring to the flowchart shown in FIG. 1.

The method starts with feeding a Henschel mixer with a polyester resin as the binding resin, which has a glass transition temperature Tg of 60° C. and a ½ flow softening temperature Tm of 110° C., a color pigment kneaded and dispersed at 40 percent by weight in advance into the binding resin, and an antistatic agent and mixing them for ten minutes to have a raw mixture (S2).

The mixture may is prepared at the following ratio depending on the desired pigment concentration in the toner.

For producing the toner containing C percent by weight of a pigment, its mixture consists mainly of:

| | | |
|---|---|---|
| Binding resin, polyester | (96-Y) | parts by weight; |
| Pigment | Y | pats by weight; |
| Carnauba wax (at 83° C. of softening | 4 | parts by weight; |
| temperature) | | |
| Antistatic agent, alkyl salicylic acid metallic | 2 | parts by weight |
| salt | | |

where C/100 = 0.4 × Y/100 is satisfied.

The pigments are C.I. pigment red 122 for the magenta color, C.I. pigment blue 15-3 for the cyan color, and C.I. pigment yellow 74 for the yellow color. The pigment in the toner is controlled to 5 to 20 percent by weight before the raw mixture is completed. For measuring the ½ flow softening temperature Tm of the binding resin, a flow tester (CFT-500 by Simazu) is used. More specifically, the temperature is measured when a half of the sample is flown out (using the sample of 1 g, the heatup temperature of 6° C., the loading of 20 kg/cm², and the nozzle of 1 mmφ×1 mm).

This is followed by fusing, kneading, and dispersing the raw mixture in a kneader, Kneadex MOS140-800 by Mitsui Mines (S4). The kneading action of Embodiment 1 is carried out under favorable conditions where the supply temperature and the discharge temperature of the front rolls are 75° C. and 50° C. respectively, the supply temperature and the discharge temperature of the back rolls are 20° C., the number of revolutions of the front rolls is 75 rpm, the number of revolution of the back rolls is 60 rpm, and the feeding speed of the raw mixture is 10 kg/h. The surface temperature of each sample of the raw mixture measured with an infrared ray non-contact thermometer is preferably not higher than 120° C. at each point in the kneading and dispersing step.

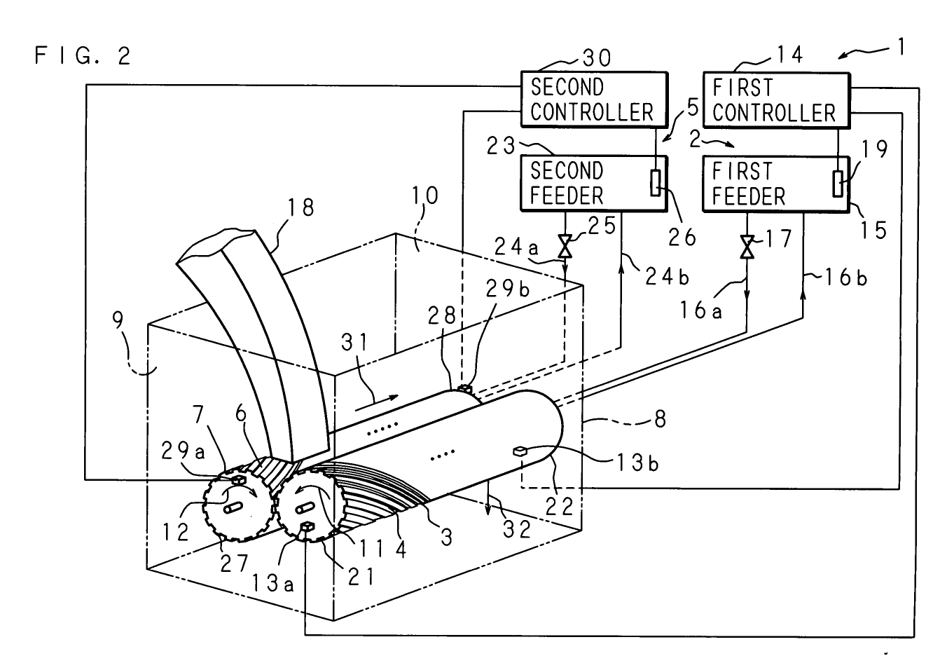

The fusing, kneading, and dispersing action may be conducted using such a kneading and dispersing apparatus (a kneader) as shown in FIG. 2. The kneading and dispersing apparatus 1 includes a first kneading roll 4 connected with a heating means 2 and having a group of spiral grooves 3 provided in the outer surface thereof and a second kneading roll 7 connected with a cooling means 5 and having a group of spiral grooves 6 provided in the outer surface thereof. The first kneading roll 4 and the second kneading roll 7 are rotatably supported by journal bearings, not shown, between a first side wall 9 and a second side wall 10 located opposite to the first side wall 9 of a casing 8 which is a hollow box-like container of substantially a rectangular parallelepiped shape having an opening provided at one side. The first kneading roll 4 and the second kneading roll 7 are spaced from each other between the opposite outer surfaces while their axes extend in parallel with each other on the same plane.

The first kneading roll 4 and the second kneading roll 7 are also coupled via toothed wheel mechanisms to two driving means respectively such as electric motors. The driving means drive the first kneading roll 4 and the second kneading roll 7 to rotate about their respective axes in two opposite directions denoted by the arrows 11 and 12. The heating means 2 connected with the first kneading roll 4 comprises a first feeder 15 for supplying a heating medium such as hot water or oil to heat up the first kneading roll 4, a pair of conduits 16a and 16b for conveying the heating medium, a flow control valve 17 mounted across the conduit 16a for controlling the feed of the heating medium, a heater 19 mounted in the first feeder 15 for directly heating the heating medium, a temperature sensor 13a for measuring the temperature at one end 21 of the first kneading roll 4 where the mixture is loaded in, a temperature sensor 13b for measuring the temperature at the other end 22 of the first kneading roll 4 where the mixture is loaded out, and a first controller 14 for controllably turning the heater 19 on and off in response to outputs of the temperature sensors 13a and 13b.

The first kneading roll 4 has an internal liquid-filled space provided therein for conveying the heating medium between an inlet and an outlet. Its inlet is connected to the conduit 16a while its outlet is connected to the other conduit 16b. This allows the first kneading roll 4 to be heated up by the heating means 2. The temperature sensors 13a and 13b may be of either contact type or non-contact type, such as a radiation thermometer. In response to the outputs of the temperature sensors 13a and 13b, the first controller 14 is actuated to hold both the one end 21 and the other end 22 of the first kneading roll 4 at desired degrees of the temperature.

The cooling means 5 connected with the second kneading roll 7 comprises a second feeder 23 for supplying a cooling medium such as chilled water to cool down the second kneading roll 7, a pair of conduits 24a and 24b for conveying the cooling medium, a flow control valve 25 mounted across the conduit 24a for controlling the feed of the cooling medium, a cooler 26 mounted in the second feeder 23 for directly cooling the cooling medium, a temperature sensor 29a for measuring the temperature at one end 27 of the second kneading roll 7, another temperature sensor 29b for measuring the temperature at the other end 28 of the second kneading roll 7, and a second controller 30 for controllably turning the cooler 26 on and off in response to outputs of the temperature sensors 29a and 29b.

Similar to the first kneading roll 4, the second kneading roll 7 has an internal liquid-filled space provided therein for conveying the cooling medium between an inlet and an outlet. Its inlet is connected to the conduit 24a while its outlet is connected to the other conduit 24b. This allows the second kneading roll 7 to be cooled down by the cooling means 2. In response to the outputs of the temperature sensors 29a and 29b, the second controller 30 is actuated to hold both the one end 27 and the other end 28 of the second kneading roll 7 at desired degrees of the temperature.

The kneading and dispersing apparatus 1 having the foregoing arrangement is supplied with the raw mixture which contains at least the binding resin and the coloring yellow pigment and is loaded from, e.g., a hopper 18 into the vicinity of the space between the first kneading roll 4 and the second kneading roll 7. As the first kneading roll 4 and the second kneading roll 7 are rotated at different circumferential speeds about their respective axes in the opposite directions, they can conduct an action of kneading the raw mixture, received from the hopper 18, under a high shearing stress along the spiral grooves 3 and 6 in their outer surfaces.

By the effect of the spiral grooves 3 and 6 of the first kneading roll 4 and the second kneading roll 7, the raw mixture is conveyed from the one ends 21 and 27 to the other ends 22 and 28 in a forward direction denoted by the arrow 31. While being conveyed, the raw mixture is compressed, fused, and dispersed uniformly by the shearing action of the two kneading rolls 4 and 7 before the coloring pigment is finally dispersed into the binding resin. Simultaneously, with the temperature of the first kneading roll 4 being controlled favorably, the raw mixture can be maintained at not higher than twice the glass transition temperature Tg of the main component of the binding resin which is polyester resin or polyether-polyol. The raw mixture after kneaded, fused, and dispersed is discharged out from the space between the first kneading roll 4 and the second kneading roll 7 in a direction denoted by the arrow 32.

The raw mixture after the steps of cooling (S6) and rough crushing (S8) is further crushed to fine particles by a jet type crusher (S10) and subjected to wind classification (S12). As sorted by a coulter multi-sizer, the particles range from 3 μm to 9 μm in the volumetric average particle diameter and stay in a distribution profile of not higher than 20 pop % at D50×0.5 or smaller and not higher than 2 vol % at D50×2 or greater.

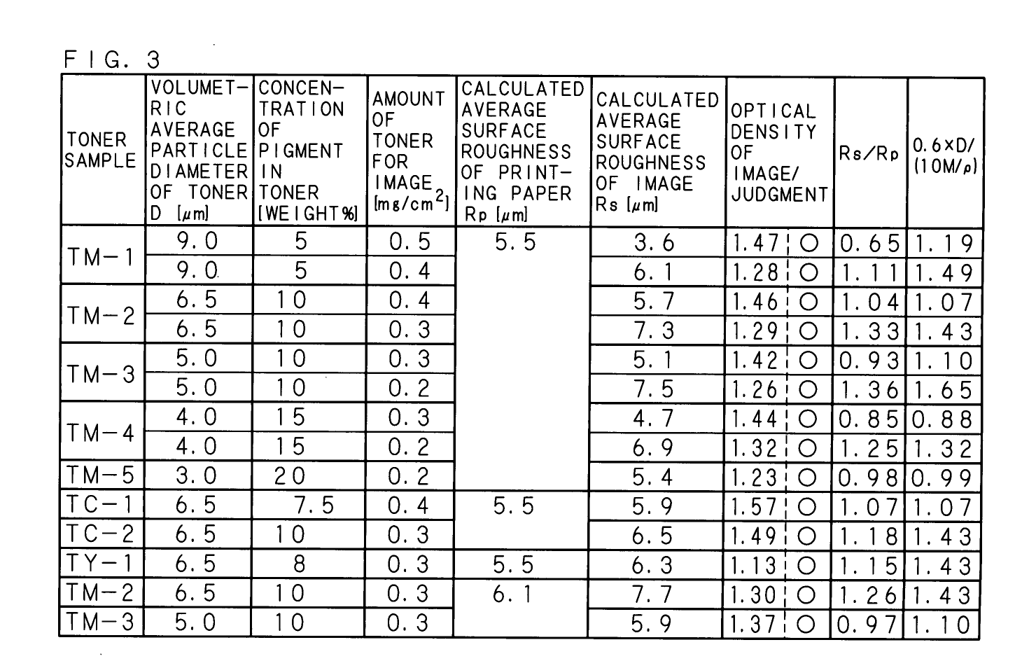

This is followed by mixing 100 percent by weight of the particles and 1.0 percent by weight of hydrophobic silica powder (120 m²/g at BET specific surface area) coated at the surface with a silane coupling agent or a dimethyl silicone oil to prepare a negative frictional chargeable toner of samples TM-1 to TM-5, TC-1, TC-2, and TY-1 shown in FIG. 3 (S14). Each samples of the toner is then added with a silicone coated ferrite core carrier of 60 μm of average particle diameter so that the concentration of the toner is 5 percent by weight in a two-component developer.

Using a printer, Sharp AR-C280, the toner of each sample was patterned and fused to generate a solid image (a printed image), 20 mm by 50 mm, on a sheet of printing paper (SF-4AM3) recommended for a Sharp printer. More particularly, the solid image was fixed with the use of an external oil-less fixing machine of which the heating roller was 40 mm in the diameter, its nip width was 6 mm against a pressing roller, and its processing speed is 117 mm/sec. The samples of TM-7 to TM-9 were fixed at 180° C. of the heating roller surface temperature while the other samples were fixed at 160° C. As the printing paper used in the embodiment 1, its calculated average surface roughness was 5.5 μm.

For determining the calculated average surface roughness of the sheet of paper and the calculated average surface roughness of the images of the samples, an ultra-depth measuring microscope, Keyence VK-8550, with its dedicated measurement program was used where each target area, 500 μm in length, at a desired location and direction on the sample images was viewed through its ×20 objective lens and examined for small undulations. When twenty of the target areas had been measured, their average was regarded as a measurement of the calculated average surface roughness. The calculated average surface roughness was calculated using the formula defined by JIS B0601-1994 “Surface Roughness”.

Also, the optical density of the samples was measured using a color spectral densitometer, X-Rite 938. It was judged good when the optical density was 1.2 or higher for the magenta sample, 1.4 or higher for the cyan sample, and 1.0 or higher for the yellow sample. The resultant measurements are shown in FIG. 3 where each sample image consuming as low as 0.2 to 0.5 mg/cm² of the toner is found favorable in the optical density. In particular, the ratio, Rs/Rp, of the calculated average surface roughness between the printing paper and the printed image is not greater than 0.6 times the value determined by D/(10 M/ρ) (where ρ=1.1 g/cm³).

The samples TM-2 and TM-3 were patterned and fixed at 160° C. of the fixing temperature to print solid images, 20 mm by 50 mm, on a sheet of printing paper (Hammermill 10326-7) recommended for a Sharp printer. The above printing paper was measured 6.1 μm in the calculated average surface roughness. Those sample images are also found favorable in the optical density while the ratio, Rs/Rp, of the calculated average surface roughness between the printing paper and the printed image is not greater than 0.6 times the value determined by D/(10 M/ρ) (where ρ=1.1 g/cm³).

(Comparison 1)

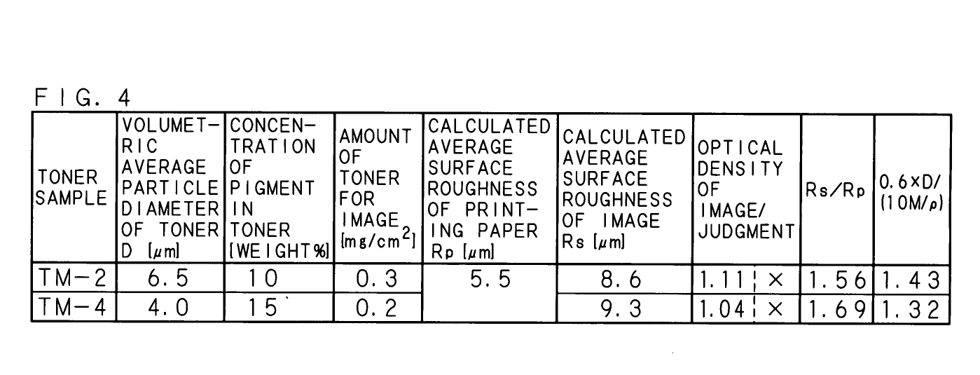

Samples of TM-2 and TM-4 were patterned by the method of Embodiment 1 and fixed at 140° C. of the fixing temperature to print solid images, 20 mm by 50 mm, on a sheet of the Sharp recommended printing paper (SF-4AM3). The sample images were then examined using the same manner as of Embodiment 1. The resultant measurements are shown in FIG. 4 where non of the sample images are found favorable in the optical density. The ratio, Rs/Rp, of the calculated average surface roughness between the printing paper and the printed image is greater than 0.6 times the value determined by D/(10 M/ρ) (where ρ=1.1 g/cm³).

### Embodiment 2

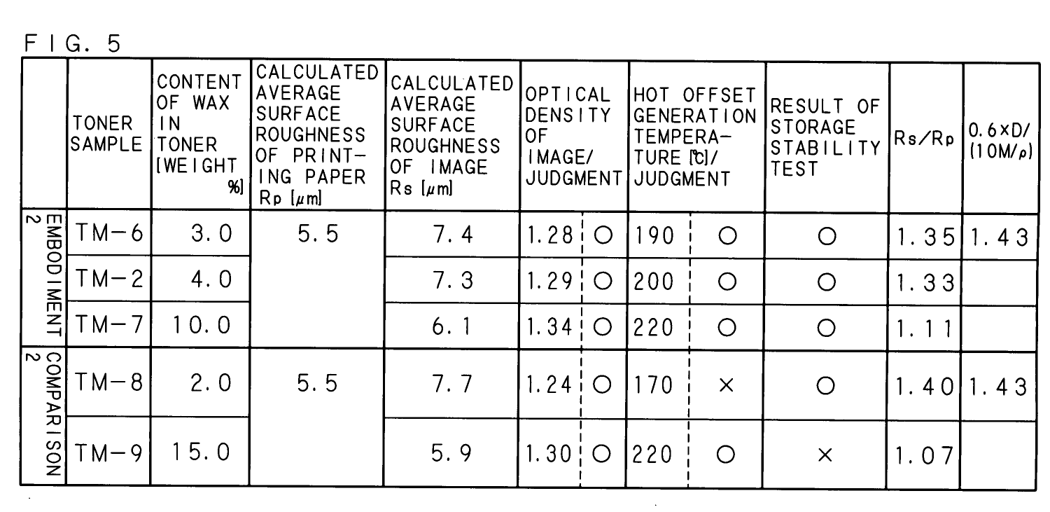

Samples of toner were produced by the same manner as of Embodiment 1, except that the concentration C of the pigment in the toner was 10 percent by weight while the amount X of the wax was set with 3 percent by weight and 10 percent by weight. As shown in FIG. 5, the resultant samples of TM-6 and TM-7 were measured 6.5 μm in the weight average particle diameter.

More specifically, the toner TM-6, TM-7 has a composition comprising:

| | | |
|---|---|---|
| binding resin, polyester | (88-W) | parts by weight; |
| Pigment | 25 | parts by weight; |
| carnauba wax (at 83° C. of softening | X | parts by weight; |
| temperature) | | |
| antistatic agent, alkyl salicylic acid metallic | 2 | parts by weight |
| salt | | |

where C/100 = 0.4 × Y/100 is satisfied.

Using the same manner as of Embodiment 1, the samples of the toner were patterned at 0.3 mg/cm² to generate printed images on a sheet of the printing paper (SF-4AM3) recommended for a Sharp printer. The printed images were examined, and subjected together with a printed image of TM-2 to a hot offset examining test and a high-temperature storage stability test after the fixing process with the same oil-less fixing machine as of Embodiment 1.

The hot offset examining test includes inspecting any undesired remaining of the toner on the fixing roller when an unfixed solid image of 10 mm wide has been deposited with 0.3 mg/cm² of the toner, by the same manner as of Embodiment 1, on a region, 10 mm to 20 mm from the leading end, of the Sharp recommended printing paper (SF-4AM3), except that the fixing temperature was varied. It was concluded that with its fixing roller fouled with a remaining of the toner, the oil-less fixing machine must not be used when the fixing temperature was lower than 180° C.

The storage stability test was conducted in which 150 g of the toner was contained in a air-tightly sealed 500-ml bottle, left still in a constantly warm vessel at 50° C. for 48 hours, cooled down to the room temperature for 8 hours, passed through a 100-μm mesh using a low tap, and measured its remaining on the mesh. When the remaining was not greater than 1 g, the toner passed the test.

The resultant measurements are shown in FIG. 5 where each of the toner samples is favorable in the image quality while exhibiting a sufficient level of the hot offset characteristic with the oil-less fixing machine and a favorable degree of the high-temperature storage stability.

(Comparison 2)

Samples of toner, TM-8 and TM-9 shown in FIG. 5, were produced by the same method as of Embodiment 2, except that the amount X of the wax was set with 2 percent by weight and 15 percent by weight and then examined by the same manner as of Embodiment 2. The resultant measurements are shown in FIG. 5 where the sample with its wax addition of 2 percent by weight fails to provide a desired level of the hot offset characteristic and the other sample with its wax addition of 15 percent by weight is found unfavorable because its storage stability test generated an event of blocking.

### Embodiment 3

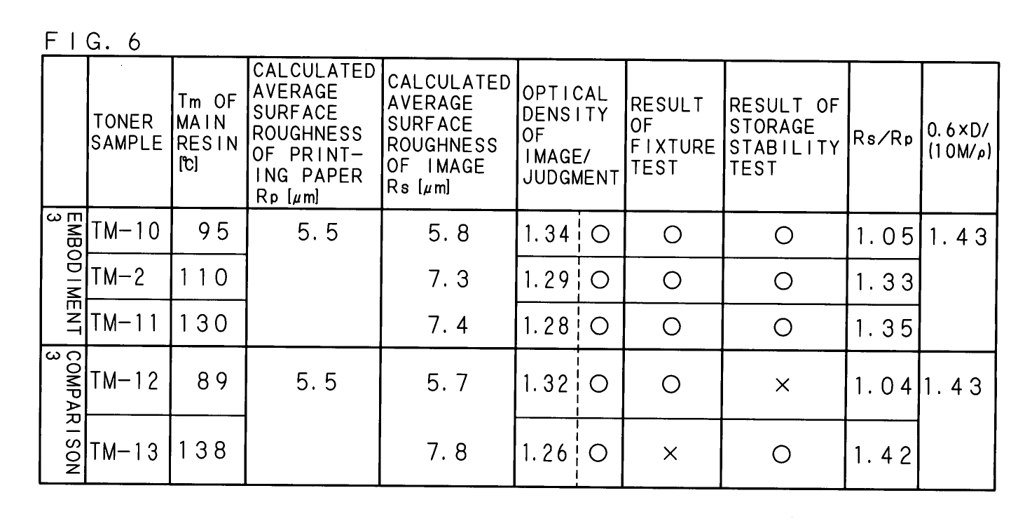

Samples of the toner, TM-10 and TM-11 shown in FIG. 6, were produced by the same method as of Embodiment 1, except that the binding resin was a polyester resin having 60° C. of the glass transition temperature Tg and 95° C. and 130° C. of the ½ flow softening point temperature Tm respectively while the magenta pigment of C.I. pigment red 122 was 10 percent by weight. The samples TM-10 and TM-11 were then patterned and fused at 0.3 mg/cm² by the same manner as of Embodiment 1. The printed images of the samples, TM-10 and TM-11, were examined and subjected to a fixture strength test. The resultant measurements are shown in FIG. 6, exhibiting favorable characteristics.

The fixture strength test for each sample included folding its printed image inwardly, pressing and loading the image along the folded line with a roller of 850 g being rolled forward and backward in one cycle, and rubbing the image five times along the bonded line with a brush.

Then, the folded line of the printed image of the toner sample was inspected by view for judgment from the following four different grades.

ο: The width is as narrow as less than 0.3 mm with the toner layer fused and fixed tightly.

Δ: The width is about 0.5 mm and no actual defect is found.

×: The width is wider and not uniform with the toner layer fixed poorly.

(Comparison 3)

Samples of toner, TM-12 and TM-13 shown in FIG. 6, were produced by the same method as of Embodiment 3, except that the binding resin was a polyester material having 60° C. of the glass transition temperature Tg and 89° C. and 140° C. of the ½ flow softening point temperature Tm respectively. The resultant measurements from the storage stability test and the fixture strength test are shown in FIG. 6, exhibiting poor, unfavorable characteristics.

### Embodiment 4

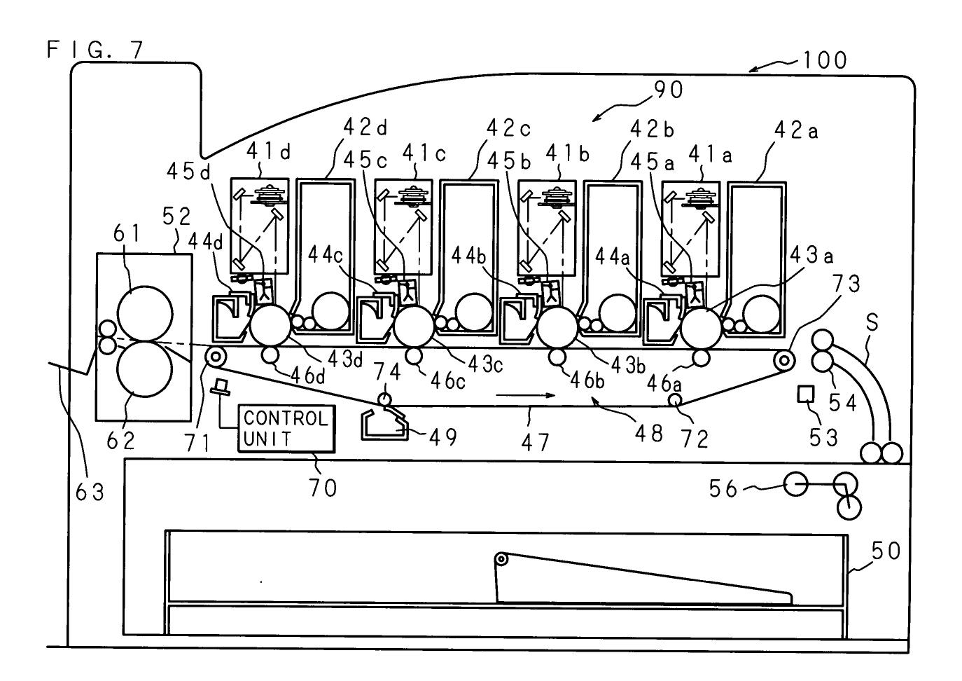

FIG. 7 is a schematic cross sectional view showing the cross section of an image forming apparatus according to Embodiment 4 of the present invention where the image forming method is carried out. The image forming apparatus denoted at 100 comprises a paper supply tray 50, a paper discharge tray 63, a fixing unit 52, an image forming module 90, a transfer conveyor belt unit 48, and a temperature/moisture sensor 53.

The paper supply tray 50 is mounted to the lower stage of the image forming apparatus 100 for storage of sheets of paper to be printed. The paper discharge tray 63 is mounted at the center left in the image forming apparatus 100 for receiving at a face-up mode the sheets of paper on which images have been printed down.

The fixing unit 52 is disposed close to the paper discharge tray 63 at the upstream of the paper conveying path and accommodates a heating roller 61 and a pressing roller 62 therein. The temperature of the heating roller 61 is controlled to a desired degree in response to the detection of a temperature detector not shown. The heating roller 61 and the pressing roller 62 are rotated with a toner image carried paper running between them. The toner image is then fused for fixing to the paper by the heating action of the heating roller 61.

The image forming module 90 is provided at the upstream side of the fixing unit 52 and at the intermediate stage of the image forming apparatus 100. The image forming module 90 consists mainly of four image forming stations (image forming means) provided for the colors: black (K), cyan (C), magenta (M), and yellow (Y), lined along the stream of paper. The four image forming stations include exposure units 41a, 41b, 41c, and 41d, developing units 42a, 42b, 42c, and 42d, photosensitive drums 43a, 43b, 43c, and 43d, cleaner units 44a, 44b, 44c, and 44d, and charging units 45a, 45b, 45c, and 45d respectively, for producing four latent color images. The sub symbols a, b, c, and d represent the four, black (K), cyan (C), magenta (M), and yellow (Y), colors respectively.

For simplicity, the five components in each of the four image forming stations will be denoted hereinafter as an exposure unit 41, a developing unit 42, a photosensitive drum 43, a cleaner unit 44, and a charging unit 45, except that the component for one of the four colors is selectively explained.

The exposure unit 41 may be either a write head composed of an array of light emitting elements such as EL (electro luminescence) and LEDs (light emitting diodes) or a laser scanning unit (LSU) provided with a laser emitter and a reflection mirror. The LSU is used in this embodiment. The exposure unit 41 emits a pattern of light representing the image to be printed to form its static latent image on the photosensitive drum 43.

The developing unit 42 converts the static latent image into a toner image on the photosensitive drum 43 using the four colors of the toner of the present invention. The photosensitive drum 43 is located in the center of each the image forming station for formings a static latent image and its toner image on its circumferential surface according to the imputted image data. The cleaner unit 44 removes and recovers the remaining of the toner left on the surface of the photosensitive drum 43 when the toner image converted from the static latent image has been transferred onto a sheet of printing paper.

The charging unit 45 charges the circumferential surface of the photosensitive drum 43 to a uniform level of potential. The charging unit 45 may be selected from known roller type, brush type, and charger type which remains not in direct contact with the circumferential surface of the photosensitive drum 43. The transfer conveyor belt unit 48 is located beneath the photosensitive drum 43 and comprises a transfer belt 47, a transfer belt driving roller 71 for driving the transfer belt 47 at the downstream side, a transfer belt tensioning roller 73 for tensioning the transfer belt 47 at the upstream side, a pair of transfer belt idle rollers 72 and 74 disposed at an intermediate of the transfer belt 47, a transfer roller 46 (46a, 46b, 46c, and 46d) disposed for directly supporting the photosensitive drum 43 from below, and a transfer belt cleaning unit 49 disposed beneath and at the trailing end of the transfer belt 47.

Although the four transfer rollers 46a, 46b, 46c, and 46d are provided for the four colors of the toner, they will be explained as the transfer rollers 46 for simplicity. The transfer roller 46 is rotatably supported by the housing of the transfer belt unit 48. The transfer roller 46 has a metal shaft of 8 to 10 mm in diameter provided as a base in the center thereof and is coated at the surface with an electrically conductive elastic material such as EPDM (ethylene propylene diene copolymer) or foamed urethane. The electrically conductive elastic material allows the transfer roller 46 to uniformly apply a high voltage, of which the polarity is opposite to that of the toner, to the sheet of printing paper for ease of transferring the toner image from the circumferential surface of the photosensitive drum 43 to the sheet of printing paper (a transfer medium) which is suctioned and conveyed by the upper side of the transfer belt 47.

The transfer belt 47 is an endless form of synthetic film, 100 μm in thickness, such as polycarbonate, polyimide, polyamide, poly-vinylidene-fluoride, poly-tetra-fluoroethylene polymer, or ethylene-tetra-fluoroethylene polymer. The transfer belt 47 is provided for running between the photosensitive drum 43 and the transfer roller 46 at each station. The toner images of the four different colors developed on the corresponding photosensitive drums 43 are transferred in a sequence onto the sheet of printing paper which is suctioned by and conveyed on the transfer belt 47, thus forming a full-color print.

The transfer belt cleaning unit 49 removes and recovers the remaining of the toner from the upper surface of the transfer belt 47 which has been adhered through the process controlling action and the contacting action with the photosensitive drums 43. The temperature/moisture sensor 53 is disposed adjacent to the processing station, where there are no abrupt changes in both the temperature and the moisture, for measuring the temperature and the moisture in the image forming apparatus 100.

In each image forming station of the image forming apparatus 100, the static latent image is generated on the photosensitive drum 43 by the exposure unit 41 emitting a pattern of light representing the image data at predetermined timing. Then, the static latent image is converted into a toner image by the action of the developing unit 42 using the toner of the present invention. The toner image is transferred onto the sheet of printing paper suctioned and conveyed on the transfer belt 47.

The transfer belt 47 is driven and rotated by the transfer belt driving roller 71, the transfer belt tensioning roller 73, the transfer belt idle rollers 72 and 74, and the transfer roller 46. The four toner images in different colors developed at the corresponding image forming stations are then transferred in a sequence onto the sheet of printing paper suctioned and conveyed on the transfer belt 47, thus forming a full-color print.

The image forming method according to the present invention in the image forming apparatus 100 will be described in more detail.

The image forming apparatus 100 upon receiving an image data drives each exposure unit 41 to emit a pattern of light to generate a static latent image on the corresponding photosensitive drum 43. The static latent image is then converted into a toner image by the action of the developing unit 42 using the toner of the present invention.

Sheets of printing paper stored in the paper supply tray 50 are picked up one by pickup rollers 56, passed through a supply passage S, and temporarily held by resist rollers 54. In response to the detection signal from a pre-resist detection switch not shown, the resist rollers 54 load the sheet of printing paper onto the transfer belt 47 as are timed with the rotating action of the photosensitive drum 43 so that the toner image developed on the photosensitive drum 43 is aligned with the leading end of an imaging area on the sheet of printing paper. The sheet of printing paper is suctioned and conveyed by the action of the transfer belt 47.

The transfer of the toner image from the photosensitive drum 43 onto the sheet of printing paper is triggered by the transfer roller 46 rotating as contacting via the transfer belt 47 with the photosensitive drum 43. More particularly, the transfer roller 46 is applied with a high voltage of which the polarity is opposite to that of the toner image. This allows the toner image to be transferred onto the sheet of printing paper. The toner images of the four different colors are transferred in a sequence onto the sheet of printing paper being conveyed by the transfer belt 47, thus forming a full-color print. The sheet of printing paper is then received by the fixing unit 52 where the toner images are fused and fixed by thermal pressing process. Finally, the sheet of printing paper on which the full-color image is printed is conveyed to the paper discharge tray 63.

Upon completing the transfer of the toner image onto the sheet of printing paper, each of the cleaner units 44 is actuated to remove and recover the remaining of the toner from the corresponding photosensitive drum 43. Simultaneously, the transfer belt cleaning unit 49 starts removing and recovering the remaining of the toner from the transfer belt 47 before one cycle of the image forming action is finished.

The image forming method of the embodiment described above employs a direct transfer technique for transferring a set of the toner images formed on the photosensitive drums 43 onto the sheet of printing paper which is conveyed by the transfer belt 47 but is not of limitations. It would be understood that the present invention is also applicable with equal success to an intermediate transfer type image forming method where a number of toner images in each color formed on the photosensitive drum are transferred onto sheets of printing paper which are then subjected to the transfer of toner images in colors for forming a full-color print.

### INDUSTRIAL APPLICABILITY

The present invention is applicable to an image forming method of developing and visualizing an electric or magnetic latent image with the use of toner powder and transferring its toner image onto a printing medium (e.g., a sheet of printing paper) before heating up for fusing and fixing as implemented in an image forming apparatus such as an electronic photography type copier or printer. It is also applicable to an electro-photographic toner for use in a one-component or two-component developing process of the image forming method and to a method of producing the toner.

1-5. (canceled)

6. A toner containing a binding resin and a coloring pigment, the coloring pigment ranging from 5 percent by weight to 20 percent by weight, the average volumetric particle diameter D being 3 to 9 μm, wherein
the calculated average surface roughness Rs of a solid image developed and fixed at 0.2 to 0.5 mg/cm² of the adhered amount M on a transfer medium of which the calculated average surface roughness Rp is 5 to 7 μm, satisfies an relational expression Rs/Rp≦0.6×D/(10 M/ρ), where ρ is the true specific gravity of the toner in g/cm³.

7. The toner according to claim 6, further containing:
3 to 10 percent by weight of a mold lubricant.

8. The toner according to claim 6, wherein
the ½ flow softening point temperature at which ½ the material is softened and flows, ranges from 95° C. to 130° C.

9. The toner according to claim 7, wherein
the ½ flow softening point temperature at which ½ the material is softened and flows, ranges from 95° C. to 130° C.

10. A toner producing method of, after fusing, kneading, and dispersing a mixture of materials by the fusing and kneading action of a kneader, subjecting the mixture to a crushing process to produce the toner defined in claim 6, wherein
the kneader is used having a first kneading roll, which has grooves for conveying the mixture and a heating region for heating the mixture, and a second kneading roll, which has grooves for conveying the mixture and a cooling region for cooling the mixture, arranged in parallel to and spaced by a gap from each other, so that the mixture is loaded with a shearing force by the first and second kneading rolls rotating in opposite directions when passing through the gap.

11. A toner producing method of, after fusing, kneading, and dispersing a mixture of materials by the fusing and kneading action of a kneader, subjecting the mixture to a crushing process to produce the toner defined in claim 7, wherein
the kneader is used having a first kneading roll, which has grooves for conveying the mixture and a heating region for heating the mixture, and a second kneading roll, which has grooves for conveying the mixture and a cooling region for cooling the mixture, arranged in parallel to and spaced by a gap from each other, so that the mixture is loaded with a shearing force by the first and second kneading rolls rotating in opposite directions when passing through the gap.

12. A toner producing method of, after fusing, kneading, and dispersing a mixture of materials by the fusing and kneading action of a kneader, subjecting the mixture to a crushing process to produce the toner defined in claim 8, wherein
the kneader is used having a first kneading roll, which has grooves for conveying the mixture and a heating region for heating the mixture, and a second kneading roll, which has grooves for conveying the mixture and a cooling region for cooling the mixture, arranged in parallel to and spaced by a gap from each other, so that the mixture is loaded with a shearing force by the first and second kneading rolls rotating in opposite directions when passing through the gap.

13. A toner producing method of, after fusing, kneading, and dispersing a mixture of materials by the fusing and kneading action of a kneader, subjecting the mixture to a crushing process to produce the toner defined in claim 9, wherein
the kneader is used having a first kneading roll, which has grooves for conveying the mixture and a heating region for heating the mixture, and a second kneading roll, which has grooves for conveying the mixture and a cooling region for cooling the mixture, arranged in parallel to and spaced by a gap from each other, so that the mixture is loaded with a shearing force by the first and second kneading rolls rotating in opposite directions when passing through the gap.

14. An image forming method of developing and visualizing an electric or magnetic latent image with the use of a toner in an electronic photography technique and transferring its toner image onto a transfer medium before being heated for fixture, wherein
the development is carried out using the toner defined in claim 6.

15. An image forming method of developing and visualizing an electric or magnetic latent image with the use of a toner in an electronic photography technique and transferring its toner image onto a transfer medium before being heated for fixture, wherein
the development is carried out using the toner defined in claim 7.

16. An image forming method of developing and visualizing an electric or magnetic latent image with the use of a toner in an electronic photography technique and transferring its toner image onto a transfer medium before being heated for fixture, wherein
the development is carried out using the toner defined in claim 8.

17. An image forming method of developing and visualizing an electric or magnetic latent image with the use of a toner in an electronic photography technique and transferring its toner image onto a transfer medium before being heated for fixture, wherein
the development is carried out using the toner defined in claim 9.
